(19) United States
(12) Patent Application Publication
(10) Pub. No.: US 2023/0134387 A1
(43) Pub. Date: May 4, 2023

(54) DEVICE FOR REDUCING CONTAMINATION OF HEAT EXCHANGE FINS

(71) Applicant: Richard R. Haemerle, Valley Park, MO (US)

(72) Inventor: Richard R. Haemerle, Valley Park, MO (US)

(21) Appl. No.: 18/051,537

(22) Filed: Nov. 1, 2022

Related U.S. Application Data
(60) Provisional application No. 63/274,628, filed on Nov. 2, 2021.

(51) Int. Cl. B01D 46/10; F24F 8/10

(52) U.S. Cl. CPC B01D 46/10; F24F 8/10; B01D 2275/203

(57) ABSTRACT

A flexible filter for an opening leading to a heat transfer surface of a heat exchanger includes a sheet of an anti-static mesh flexible filter screen configured with a perimeter extending beyond edges of the opening; and at least one mounting strip attached to at least a portion of a perimeter of the sheet of filter screen. A method protecting a heat transfer surface of a heat exchanger from contamination by preventing airborne particulates from passing through an opening leading to the heat transfer surface with the flexible filter is also provided.

### CROSS REFERENCE

This application claims priority to U.S. Provisional Application Ser. No. 63/274,628 filed on Nov. 2, 2021, the entire disclosure of which is hereby incorporated by reference.

### TECHNICAL FIELD

The present disclosure is directed to filters and, more particularly, to filters for heat exchangers, for example air conditioning units.

### BACKGROUND

Heat exchanging fins, coils, and similar structures, for example, in air conditioning units, refrigerators, and other products, are prone to significant accumulation of dust, dirt, and other debris. The accumulated debris on these heat exchanging structures interferes with the heat exchange process and, as a result, significantly decreases the operating efficiency of the heat exchanger and increases the cost of operating the heat exchanger. Further, failure to regularly clean a heat exchanger to remove the accumulated debris can significantly shorten the lifespan of the heat exchanger. While condenser units are frequently provided with a metal or wire protective screen, such screens are themselves prone to clogging with debris over time.

Therefore, it has been important to regularly clean these heat exchangers. However, this is a laborious process and can be quite difficult and time consuming. In the past, using filter elements to protect the heat exchanging components has not been widely used because the available products interfered with the flow of air to and from the heat exchanger, again decreasing operating efficiency and increasing the cost of operation.

Therefore, a need exists for an improved means of reducing or eliminating the accumulation of debris on air conditioning fins, refrigerator coils, and similar heat exchanging structures.

### SUMMARY OF THE DISCLOSURE

According to an aspect of the present disclosure, there is provided a flexible filter for an opening leading to a heat transfer surface of a heat exchanger includes a sheet of an anti-static mesh flexible filter screen configured with a perimeter extending beyond edges of the opening; and at least one mounting strip attached to at least a portion of a perimeter of the sheet of filter screen.

According to another aspect of the present disclosure, there is provided a method protecting a heat transfer surface of a heat exchanger from contamination by preventing airborne particulates from passing through an opening leading to the heat transfer surface with the flexible filter is also provided.

These aspects are merely illustrative of the innumerable aspects associated with the present disclosure and should not be deemed as limiting in any manner. These and other aspects, features and advantages of the present disclosure will become apparent from the following detailed description when taken in conjunction with the referenced drawings.

### DESCRIPTION OF DRAWINGS

Reference is now made more particularly to the drawings, which illustrate the best presently known mode of carrying out the disclosure and wherein similar reference characters indicate the same parts throughout the views.

FIG. 1 is an illustration of an air conditioning unit condenser unit showing condenser coil fins.

FIG. 2 is a schematic illustration of an embodiment of a flexible filter according to the present disclosure.

### DETAILED DESCRIPTION

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. The following definitions and non-limiting guidelines must be considered in reviewing the description of the technology set forth herein.

The headings (such as “Introduction” and “Summary”) and sub-headings used herein are intended only for general organization of topics within the present disclosure and are not intended to limit the disclosure of the technology or any aspect thereof. In particular, subject matter disclosed in the “Introduction” may include novel technology and may not constitute a recitation of prior art. Subject matter disclosed in the “Summary” is not an exhaustive or complete disclosure of the entire scope of the technology or any embodiments thereof. Classification or discussion of a material within a section of this specification as having a particular utility is made for convenience, and no inference should be drawn that the material must necessarily or solely function in accordance with its classification herein when it is used in any given composition.

The citation of references herein does not constitute an admission that those references are prior art or have any relevance to the patentability of the technology disclosed herein. All references cited in the “Description” section of this specification are hereby incorporated by reference in their entirety.

The description and specific examples, while indicating embodiments of the technology, are intended for purposes of illustration only and are not intended to limit the scope of the technology. Moreover, recitation of multiple embodiments having stated features is not intended to exclude other embodiments having additional features, or other embodiments incorporating different combinations of the stated features. Specific examples are provided for illustrative purposes of how to make and use the apparatus and systems of this technology and, unless explicitly stated otherwise, are not intended to be a representation that given embodiments of this technology have, or have not, been made or tested.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates at least variations that may arise from ordinary methods of measuring or using such parameters. In addition, disclosure of ranges includes disclosure of all distinct values and further divided ranges within the entire range.

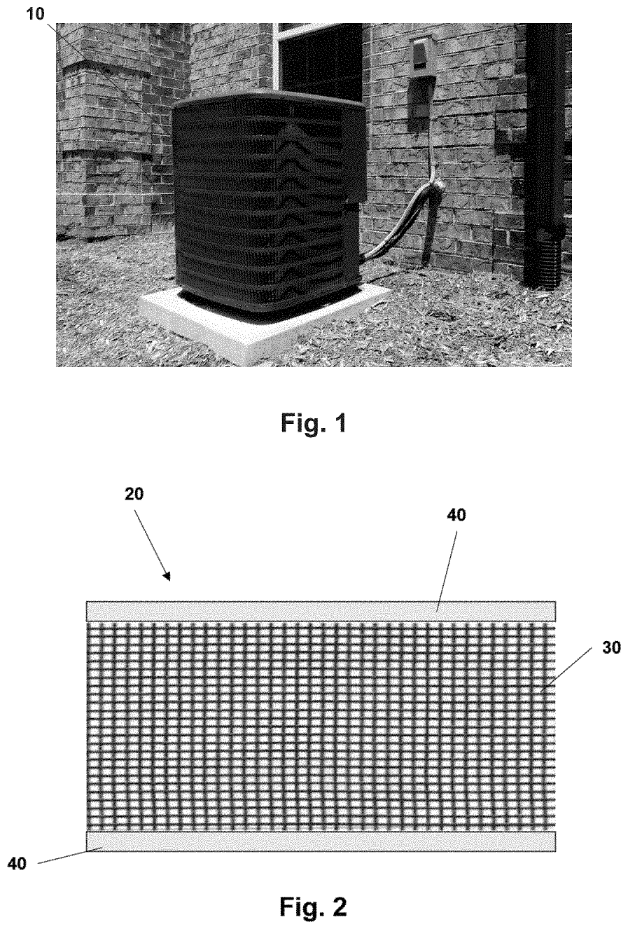

FIG. 1 schematically illustrates a typical condenser unit for a residential or commercial air conditioner, which is located outside of the conditioned space. The condenser unit includes, among other components, condenser coils in which refrigerant condenses and allows for the release of excess heat to the surrounding atmosphere. The condenser unit will typically include a condenser fan that blows air over the condenser coil to accelerate the heat transfer process.

The condenser coils include a series of heat exchanging fins 10 that provide for greater surface area to encourage rapid heat transfer. These fins 10 generally surround the entire exterior of the condenser unit and, therefore, are the most exposed to environmental effects and potential damage resulting from that exposure to the environment and weather. Because of their central role in the heat transfer process, it is essential that the fins 10 have significant exposure to open air. Therefore, it is not feasible to either redesign the condenser unit to locate the fins 10 in a more protected, internal position or to provide protective shielding, either of which may significantly impede air flow across the fins 10 and negatively affect the efficiency, performance, and lifespan of the condenser unit.

Further, because these fins 10—as a function of their design to provide increased surface area for heat transfer—are thin pieces of metal that are vulnerable to deformation from exposure to the weather as well as impact from other objects that may contact the fins 10. Deformation of the fins 10 can also significantly impact the performance, efficiency, and lifespan of the condenser unit.

FIG. 1 illustrates an embodiment of a filter screen 20 according to the present disclosure. The filter screen 20 includes a sheet of screen material 30. The filter screen 20 in the illustrated embodiment is rectangular in correlation with the shape and arrangement of the condenser coils of the exemplary condenser unit shown. However, the shape of the filter screen 20 may be changed to accommodate the shape of the device being protected. The filter screen 20 preferably is provided with outer dimensions slightly greater than the opening in the housing of the condenser unit within which the condenser coil fins are located. This arrangement allows for mounting of the filter screen 20 on the housing, which extends further outward than the condenser coil fins. Therefore, the filter screen 20 is kept a slight distance from and does not directly contact the condenser coil fins. This configuration prevents any debris caught by the filter screen 20 from contacting the condenser coil fins.

The filter screen 20 is provided with at least one mounting strip 40. The mounting strip 40 may be an adhesive strip that is adhered, sewn, enmeshed, or otherwise secured to the sheet of screen material 30. In the case of an adhesive strip, the mounting strip 40 may be a single piece attached to the sheet of screen material 30 without any corresponding piece attached to the housing of the condenser unit. Instead, the adhesive strip is simply applied to the housing. The adhesive strip may be provided with a removable backing to prevent the adhesive strip from inadvertently adhering to another surface prior to installation on the condenser unit housing. In a preferred embodiment, the mounting strip 40 may extend along each side of the filter screen 20. Alternately, the mounting strip 40 may extend only along one side of the filter screen 20 or two sides of the filter screen 20. The mounting 40 strip may be continuous or discontinuous.

In alternate embodiments, the mounting strip 40 may be composed of a two-piece arrangement that includes a first mounting part secured to the sheet of screen material 30 and a second mounting part that is secured to the condenser unit housing. In a first such embodiment, the first and second mounting parts may comprise corresponding magnetic strips with opposing polarity such that they attract one another in order to secure the sheet of screen material 30 to the housing. In another exemplary embodiment, the first mounting part may be one side of a hook and loop fastener while the second mounting part is the mating side of the fastener. The second mounting part may be secured to the condenser unit housing with an adhesive.

Other mounting arrangements may be utilized with the understanding that it is preferred that the mounting strip 40 allow for the removal of the sheet of screen material 30 and replacement thereof if necessary.

In one embodiment, the screen material used is a polyester or nylon mesh. In another embodiment, the screen material is an anti-static mesh. In embodiments utilizing an anti-static mesh, it has been found that environmental debris, such as plant pollen, is less prone to stick to the screen material, which reduces the frequency of cleaning or replacement necessary.

Embodiments of the present disclosure are suitable for a variety of applications. Examples include protection of residential and commercial HVAC condenser coil fins, RV or other mobile vehicles having exterior condenser units, refrigerator coils, and refrigeration units on refrigerated semi-trailers. While many of the preceding applications may involve permanent installation of systems incorporating embodiments of the filter screen 10, it is also suitable for temporary use, for example, during construction, renovation, or remodeling projects in which debris will be created during demolition or other construction phases. With respect to the latter application, embodiments of the filter screen 10 may also be applied to interior intake vents or similar airflow openings to minimize intrusion of construction debris into the vent and ductwork.

The preferred embodiments of the disclosure have been described above to explain the principles of the invention and its practical application to thereby enable others skilled in the art to utilize the invention. However, as various modifications could be made in the constructions and methods herein described and illustrated without departing from the scope of the invention, it is intended that all matter contained in the foregoing description or shown in the accompanying drawings, including all materials expressly incorporated by reference herein, shall be interpreted as illustrative rather than limiting. Thus, the breadth and scope of the present invention should not be limited by the above-described exemplary embodiment but should be defined only in accordance with the following claims appended hereto and their equivalents.

What is claimed is:

1. A flexible filter for an opening leading to a heat transfer surface of a heat exchanger, comprising:
a sheet of an anti-static mesh flexible filter screen configured with a perimeter extending beyond edges of the opening; and
at least one mounting strip attached to at least a portion of a perimeter of the sheet of filter screen.

2. The flexible filter as set forth in claim 1, wherein the sheet of anti-static mesh flexible filter screen further comprises a nylon or polyester mesh material.

3. The flexible filter as set forth in claim 1, wherein the at least one mounting strip comprises an adhesive strip.

4. The flexible filter as set forth in claim 1, wherein the at least one mounting strip comprises a magnetic strip.

5. The flexible filter as set forth in claim 4, wherein the magnetic strip comprises a first part and a second part wherein the first part is secured to the edges of the opening and the second part is secured to the perimeter of the sheet of anti-static mesh flexible filter screen and wherein the first part and second part of the magnetic strip of opposing polarities.

6. The flexible filter as set forth in claim 1, wherein the at least one mounting strip is a hook and loop fastener.

7. A flexible filter for an opening leading to a heat transfer surface of a heat exchanger, comprising:
a sheet of flexible filter screen configured with a perimeter extending beyond edges of the opening; and
at least one mounting strip attached to at least a portion of a perimeter of the sheet of filter screen.

8. The flexible filter as set forth in claim 7, wherein the sheet of screen material further comprises a nylon or polyester mesh material.

9. The flexible filter as set forth in claim 7, wherein the at least one mounting strip comprises an adhesive strip.

10. The flexible filter as set forth in claim 7, wherein the at least one mounting strip comprises a magnetic strip.

11. The flexible filter as set forth in claim 10, wherein the magnetic strip comprises a first part and a second part wherein the first part is secured to the edges of the opening and the second part is secured to the perimeter of the sheet of filter screen and wherein the first part and second part of the magnetic strip of opposing polarities.

12. The flexible filter as set forth in claim 7, wherein the at least one mounting strip is a hook and loop fastener.

13. The flexible filter as set forth in claim 7, wherein the sheet of flexible filter screen comprises an anti-static mesh nylon or polyester material.

14. A method protecting a heat transfer surface of a heat exchanger from contamination by preventing airborne particulates from passing through an opening leading to the heat transfer surface, comprising the steps of:
providing a filter screen comprising:
sheet of an anti-static mesh flexible filter screen configured with a perimeter extending beyond edges of the opening; and
at least one mounting strip attached to at least a portion of a perimeter of the sheet of filter screen; and
securing the mounting strip to at least the portion of the edges of the opening.

15. The method of protecting a heat transfer surface as set forth in claim 14, wherein the at least one mounting strip extends around the entire opening and the step of securing the mounting strip further comprises securing the mounting strip around all the edges of the opening.

16. The method of protecting a heat transfer as set forth in claim 14, further comprising the step of cutting the sheet of anti-static mesh flexible filter screen to match a shape of the opening prior to attaching the at least one mounting strip to the at least a portion of the perimeter of the sheet of anti-static mesh flexible filter screen.

17. The method of protecting a heat transfer surface as set forth in claim 14, wherein the sheet of anti-static mesh flexible filter screen further comprises a nylon or polyester mesh material.

18. The method of protecting a heat transfer surface as set forth in claim 14, wherein the at least one mounting strip comprises an adhesive strip.

19. The method of protecting a heat transfer surface as set forth in claim 14, wherein the at least one mounting strip comprises a magnetic strip.

20. The method of protecting a heat transfer surface as set forth in claim 19, wherein the magnetic strip comprises a first part and a second part wherein the first part is secured to the edges of the opening and the second part is secured to the perimeter of the sheet of anti-static mesh flexible filter screen and wherein the first part and second part of the magnetic strip of opposing polarities.
